(19) United States
(12) Patent Application Publication
(10) Pub. No.: US 2021/0031218 A1
(43) Pub. Date: Feb. 4, 2021

(54) SOLENOID VALVE FOR SPRAY BARK STOPPER

(71) Applicant: SHENZHEN TRANSPET TECHNOLOGY CO., LTD., Shenzhen City (CN)

(72) Inventor: XINGWEN YAN, Shenzhen City (CN)

(21) Appl. No.: 16/742,112

(22) Filed: Jan. 14, 2020

(30) Foreign Application Priority Data
Aug. 1, 2019 (CN) 201921260769.1

(51) Int. Cl. B05B 1/30

(52) U.S. Cl. CPC B05B 1/3013

(57) ABSTRACT

Disclosed is a solenoid valve for spray bark stopper, which relates to the technical field of pet products. The solenoid valve is horizontally installed in a length direction of a bark stopper. The output end of the solenoid valve is provided with a convex body, and the convex body is used for connecting the flexible connecting pipe. By adopting the above technical solution, the flexible connecting pipe can be connected to the solenoid valve through the convex body at one end thereof, and then the output end of the solenoid valve is connected to the spout of the bark stopper, thereby changing the spray direction of the solenoid valve, so that the gas from the solenoid valve is sprayed from the spout of the middle of the bark stopper through the flexible connecting pipe and acts on the pet.

### FIELD OF THE DISCLOSURE

The present disclosure relates to the technical field of pet bark stoppers, in particular to a solenoid valve for spray bark stopper.

### BACKGROUND OF THE DISCLOSURE

With the improvement of people's living standards, more and more people keep pets, but the barking of pets, especially dogs, will cause people troubles, when people rest at night particularly. Therefore, articles that can stop dogs from barking—bark stoppers—are invented. The current bark stoppers can be divided into the following types, including ultrasonic bark stoppers, electric shock bark stoppers, spray bark stoppers, and dog masks. At present, spray bark stoppers are more commonly used, which are humane and environmentally friendly. As shown in FIGS. 1 and 2, the existing spray bark stoppers include a neckband a, a bark stopper b, a sensor c, a solenoid valve d, and a gas storage device e, in which the solenoid valve d is installed vertically along the length of the neck of the pet, and a spout f of the bark stopper corresponds to the position of the pet's nose, thereby limiting the height of the bark stopper. However, the excessive height of the bark stopper is not suitable for small pets, so it is urgent to improve the above technical problems.

### SUMMARY OF THE DISCLOSURE

The purpose of the present disclosure is to provide a spray bark stopper, which has the advantages of flexible structure, small size, and adaptability to pets of different sizes.

According to one exemplary embodiment of the present disclosure, a solenoid valve for spray bark stopper is provided, wherein the solenoid valve is horizontally installed in a length direction of a bark stopper, a convex body is provided at an output end of the solenoid valve and the convex body is configured to connect a flexible connecting pipe.

In a preferred embodiment, the solenoid valve comprises: a valve sleeve; a nozzle mounted on one end of the valve sleeve; a spray channel matched with the nozzle; a bracket provided in an inner cavity of the valve sleeve; a coil sleeved on an outside of the bracket; an iron core base of which one end is assembled between the valve sleeve and the bracket, and the other end is for assembly and communication of a gas storage device; a valve core assembly slidingly mounted inside the bracket and having one end abutting against the spray channel; and a return spring of which one end abuts against the valve core assembly, and the other end abuts against the iron core base. When a bark sensor senses a bark signal, the bark stopper controls the coil to power on, and the valve core assembly moves toward one end of the iron core base to compress the return spring and is attracted by and attached to the iron core base to open the spray channel; when the coil is powered off, the return spring drives the valve core assembly to move toward one end of the nozzle to close the spray channel.

In a preferred embodiment, the spray channel comprises: a first channel located in the iron core base and communicating with the gas storage device; a second channel provided on one end of the bracket adjacent to the nozzle and abutted by the valve core assembly, and a temporary gas storage chamber provided inside the bracket, wherein one end of the temporary gas storage chamber is in communication with the first channel and the other end is in communication with the second channel.

In a preferred embodiment, the valve core assembly comprises: a movable iron core configured to be attracted by and attached to the iron core base when the coil is powered on; a rubber pad provided at one end of the movable iron core and abutting against the second channel; and a fixing ring sleeved on the movable iron core and used for assembling the rubber pad on the movable iron core.

In a preferred embodiment, a first sealing ring is provided at one end of the bracket adjacent to the nozzle and tightly fitted into the cavity of the nozzle.

In a preferred embodiment, a second sealing ring is provided on the iron core base and tightly fitted on an inner wall of the bracket; and a groove is provided on the iron core base for receiving the second sealing ring.

In a preferred embodiment, the nozzle and the valve sleeve are connected via a screw connection.

After the above technical solution is adopted, the present disclosure has the following beneficial effects.

1. The solenoid valve in the present disclosure is horizontally installed in a length direction of a bark stopper, and can be connected to a flexible connecting pipe through the convex body at one end of the solenoid valve, so that the spout of the solenoid valve is connected with the nozzle of the bark stopper, thereby changing the spraying direction of the solenoid valve. Consequently, the gas from the solenoid valve is sprayed from the spout of the middle of the bark stopper through the flexible connecting pipe and acts on the pet, which reduces the height limit of the bark stopper and is beneficial to reduce the volume of the spray bark stopper, thereby applying to large or small pets and improving the applicability of spray bark stoppers.

2. In the present disclosure, when the bark sensor detects a bark signal, the bark stopper controls the solenoid valve to power on, thereby controlling the spray channel to open, so that the gas in the gas storage device enters the solenoid valve from one end of the iron core base, and the nozzle is used for atomizing and spraying. In addition, the first and second sealing rings are arranged in the solenoid valve, which can prevent the gas from leaking to the solenoid valve and affect the normal use of the spray bark stopper, thereby ensuring the sealing performance and prolonging service life of the product.

### BRIEF DESCRIPTION OF THE DRAWINGS

In order to more clearly explain the embodiments of the present disclosure or the technical solutions in the related art, the drawings used in the description of the embodiments or the related art will be briefly introduced below. Obviously, the drawings in the following description are merely some embodiments of the present disclosure. For those of ordinary skill in the art, other drawings can be obtained based on these drawings without paying creative labor.

FIG. 1 is a schematic structural diagram of a spray bark stopper in the related art.

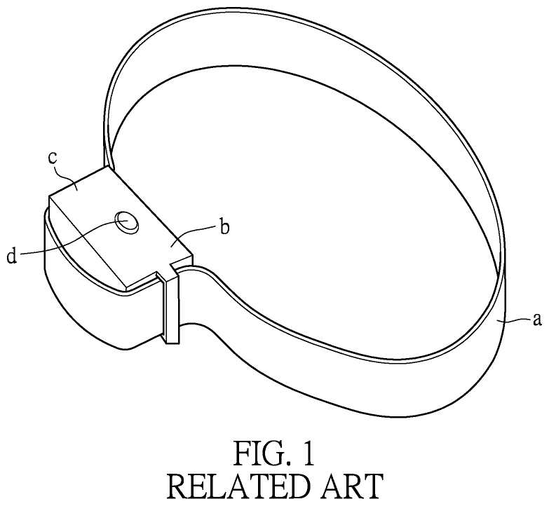

FIG. 2 is a schematic diagram of the installation of a solenoid valve for spray bark stopper in the related art.

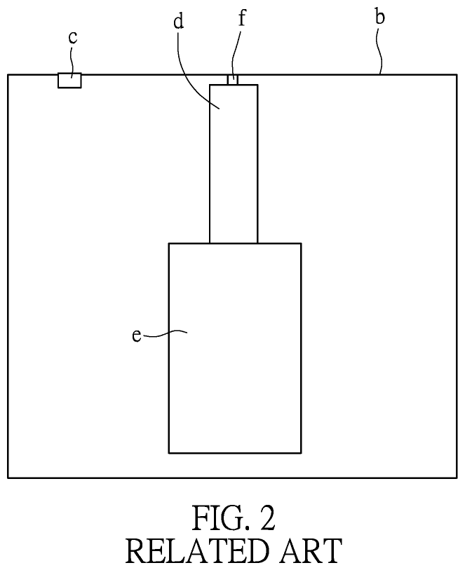

FIG. 3 is a schematic diagram of the installation of a solenoid valve in the present disclosure.

FIG. 4 is a schematic structural diagram of a solenoid valve in the present disclosure.

FIG. 5 is an exploded schematic view of a solenoid valve in the present disclosure.

FIG. 6 is a schematic sectional view of a solenoid valve in the present disclosure.

Reference numeral: B, bark stopper; E, gas storage device; D, solenoid valve; C, bark sensing member; F, spout; G, flexible connecting pipe; 1, valve sleeve; 2, nozzle; 3, spray channel; 4, bracket; 5, coil; 6, iron core base; 7, valve core assembly; 8, return spring; 31, first channel; 32, second channel; 33, temporary gas storage chamber; 71, movable iron core; 72, rubber pad; 73, fixing ring; 9, first sealing ring; 10, second sealing ring; 61, groove; 21, key groove; 22, convex body.

### DETAILED DESCRIPTION OF THE EXEMPLARY EMBODIMENTS

The present disclosure will be further described in detail below with reference to the accompanying drawings.

This specific embodiment is merely an explanation of the present disclosure, and it is not a limitation on the present disclosure. After reading this specification, those skilled in the art can make modifications that do not contribute to this embodiment as needed, but they are protected by patent law as long as they are within the scope of the claims of the present disclosure.

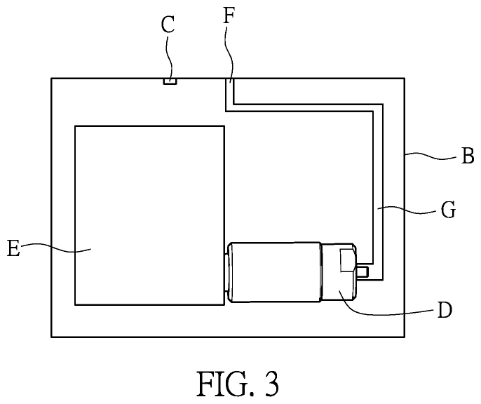

This embodiment relates to a solenoid valve for spray bark stopper. As shown in FIG. 3, the solenoid valve D is horizontally installed in a length direction of a bark stopper B. An output end of the solenoid valve D is provided with a convex body 22, and the convex body 22 is configured to connect a flexible connecting pipe G, and then the direction of the solenoid valve D can be changed through the flexible connecting pipe G. The other end of the flexible connecting pipe G can be fixed to a spout F of the bark stopper B, so as to change the direction of the spray and make the solenoid valve D to be horizontally installed in a length direction of a bark stopper B, which reduces the volume of the spray bark stopper B, facilitates the application to pets of different sizes, and improves the adaptability of the spray bark stopper B.

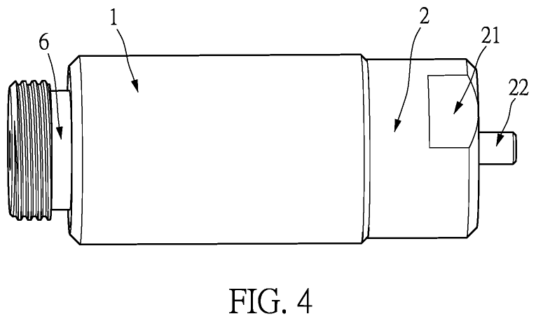

In this embodiment, as shown in FIGS. 4-6, the solenoid valve D includes: a valve sleeve 1; a nozzle 2 mounted on one end of the valve sleeve 1; a spray channel 3 matched with the nozzle 2; a bracket 4 provided in an inner cavity of the valve sleeve 1; a coil 5 sleeved on an outside of the bracket 4; an iron core base 6 of which one end is assembled between the valve sleeve 1 and the bracket 4, and the other end is for assembly and communication of a gas storage device E; a valve core assembly 7 slidingly mounted inside the bracket 4 and having one end abutting against the spray channel 3; and a return spring 8 of which one end abuts against the valve core assembly 7, and the other end abuts against the iron core base 6. When a bark sensor C senses a bark signal, the bark stopper B controls the coil 5 to power on, and the valve core assembly 7 moves toward one end of the iron core base 6 to compress the return spring 8 and is attracted by and attached to the iron core base 6 to open the spray channel 3; when the coil 5 is powered off, the return spring 8 drives the valve core assembly 7 to move toward one end of the nozzle 2 to close the spray channel 3.

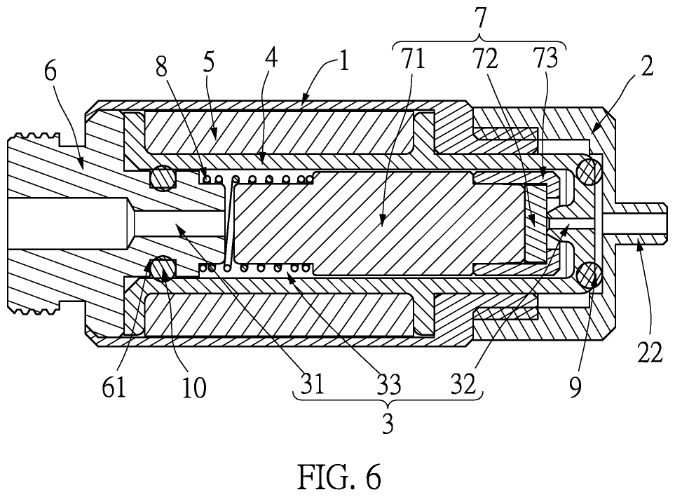

As shown in FIG. 6, the spray channel 3 includes: a first channel 31 located in the iron core base and communicating with the gas storage device E; a second channel 32 provided on one end of the bracket 4 adjacent to the nozzle 2 and abutted by the valve core assembly 7, and a temporary gas storage chamber provided inside the bracket 4, wherein one end of the temporary gas storage chamber is in communication with the first channel 31 and the other end is in communication with the second channel 32.

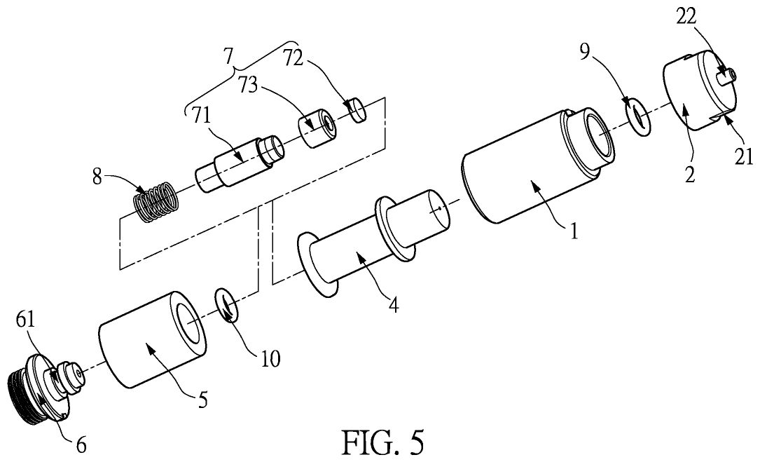

As shown in FIG. 5 and FIG. 6, the valve core assembly 7 includes: a movable iron core 71 configured to be attracted by and attached to the iron core base 6 when the coil 5 is powered on; a rubber pad 72 provided at one end of the movable iron core 71 and abutting against the second channel 32; and a fixing ring 73 sleeved on the movable iron core 71 and used for assembling the rubber pad 72 on the movable iron core 71. The rubber pad 72 has a good sealing property and can control the opening and closing of the second channel 32. The fixing ring 73 stably fixes the rubber pad 72 to one end of the movable iron core 71 to prevent the rubber pad 72 from sliding arbitrarily.

As shown in FIG. 5, a first sealing ring is provided at one end of the bracket 4 adjacent to the nozzle 2 and tightly fitted into the cavity of the nozzle 2; a second sealing ring 10 is provided on the iron core base 6 and tightly fitted on an inner wall of the bracket 4; and a groove 61 is provided on the iron core base 6 for receiving the second sealing ring 10. The first sealing ring 9 and the second sealing ring 10 ensure the tightness of the solenoid valve D and prevent the gas from leaking out and affecting the usage.

As shown in FIG. 4, in the present disclosure, the nozzle 2 is provided with two key grooves 21 for mounting on the bark stopper B. The key groove 21 has a positioning effect on the installation of the solenoid valve D, and prevents the solenoid valve D from sliding arbitrarily and prevents the connection between the nozzle 2 and the flexible connecting pipe G from falling off.

In the present disclosure, the nozzle 2 and the valve sleeve 1 are connected via a screw connection, and the iron core base 6 and the gas storage device E are also screwed. The screw connection structure is stable, easy to assemble and disassemble, and easy to replace the gas storage device E.

The working principle of the present disclosure is roughly as follows. In this embodiment, the convex body 22 is provided at one end of the solenoid valve D, and the solenoid valve D is horizontally installed in a length direction of a bark stopper B, and can be connected to the flexible connecting pipe G through the convex body 22, so that the nozzle 2 is connected to the spout F of the bark stopper B to change the spraying direction of the solenoid valve D. Consequently, the gas from the solenoid valve D is sprayed from the spout F of the middle of the bark stopper through the flexible connecting pipe G and acts on the pet, which reduces the height limit of the bark stopper B and is beneficial to reduce the volume of the spray bark stopper B, thereby applying to large or small pets and improving the applicability of spray bark stoppers. When the bark sensor C detects a bark signal, the bark stopper B controls the solenoid valve D to power on, thereby controlling the spray channel 3 to open, so that the gas in the gas storage device E enters the solenoid valve D from one end of the iron core base 6, and the nozzle 2 is used for atomizing and spraying. When the bark sensor C does not detect the bark signal, the bark stopper B cuts off the power supply to the solenoid valve D, so that the return spring 8 drives the iron core assembly 7 to move toward one end of the nozzle 2 and the spray channel 3 is closed.

The above is only used to illustrate the technical solution of the present disclosure and is not a limitation. Other modifications or equivalent substitutions made by those skilled in the art to the technical solution of the present disclosure should be covered within the scope and spirit of the technical solution of the present disclosure as long as they are within the scope of the claims of the present disclosure.

What is claimed is:

1. A solenoid valve for spray bark stopper, wherein the solenoid valve (D) is horizontally installed in a length direction of a bark stopper (B), a convex body (22) is provided at an output end of the solenoid valve (D) and configured to connect a flexible connecting pipe (G).

2. The solenoid valve for spray bark stopper according to claim 1, wherein the solenoid valve (D) comprises:
a valve sleeve (1);
a nozzle (2) mounted on one end of the valve sleeve (1);
a spray channel (3) matched with the nozzle (2);
a bracket (4) provided in an inner cavity of the valve sleeve (1);
a coil (5) sleeved on an outside of the bracket (4);
an iron core base (6) of which one end is assembled between the valve sleeve (1) and the bracket (4), and the other end is for assembly and communication of a gas storage device (E);
a valve core assembly (7) slidingly mounted inside the bracket (4) and having one end abutting against the spray channel (3); and
a return spring (8) of which one end abuts against the valve core assembly (7), and the other end abuts against the iron core base (6);
wherein when a bark sensor (C) senses a bark signal, the bark stopper (B) controls the coil (5) to power on, and the valve core assembly (7) moves toward one end of the iron core base (6) to compress the return spring (8) and is attracted by and attached to the iron core base (6) to open the spray channel (3); and
wherein when the coil (5) is powered off, the return spring (8) drives the valve core assembly (7) to move toward one end of the nozzle (2) to close the spray channel (3).

3. The solenoid valve for spray bark stopper according to claim 2, wherein the spray channel (3) comprises:
a first channel (31) located in the iron core base (6) and communicating with the gas storage device (E);
a second channel (32) provided on one end of the bracket (4) adjacent to the nozzle (2) and abutted by the valve core assembly (7); and
a temporary gas storage chamber provided inside the bracket (4), wherein one end of the temporary gas storage chamber is in communication with the first channel (31) and the other end is in communication with the second channel (32).

4. The solenoid valve for spray bark stopper according to claim 3, wherein the valve core assembly (7) comprises:
a movable iron core (71) configured to be attracted by and attached to the iron core base (6) when the coil (5) is powered on;
a rubber pad (72) provided at one end of the movable iron core (71) and abutting against the second channel (32); and
a fixing ring (73) sleeved on the movable iron core (71) and used for assembling the rubber pad (72) on the movable iron core (71).

5. The solenoid valve for spray bark stopper according to claim 4, wherein a first sealing ring (9) is provided at one end of the bracket (4) adjacent to the nozzle (2) and tightly fitted into the cavity of the nozzle (2).

6. The solenoid valve for spray bark stopper according to claim 2, wherein a second sealing ring (10) is provided on the iron core base (6) and tightly fitted on an inner wall of the bracket (4); and
wherein a groove (61) is provided on the iron core base (6) for receiving the second sealing ring (10).

7. The solenoid valve for spray bark stopper according to claim 2, wherein the nozzle (2) and the valve sleeve (1) are connected via a screw connection.
